(19) United States
(12) Patent Application Publication
(10) Pub. No.: US 2025/0248473 A1
(43) Pub. Date: Aug. 7, 2025

(54) Electrochromic Face Shield Device

(71) Applicant: Cristian Quinonez, Aurora, CO (US)

(72) Inventor: Cristian Quinonez, Aurora, CO (US)

(21) Appl. No.: 18/434,484

(22) Filed: Feb. 6, 2024

(51) Int. Cl. A42B 3/22; G02F 1/133; G02F 1/155; G02F 1/163

(52) U.S. Cl. CPC A42B 3/226; A42B 3/222; A42B 3/225; G02F 1/13324; G02F 1/155; G02F 1/163

(57) ABSTRACT

An electrochromic face shield device includes a head harness that can be worn on a user's head and a pivoting band that is pivotally attached to the head harness. The pivoting band is positionable in a first position or a second position. A face shield is attached to the pivoting band and the face shield has a clear portion and an opaque portion. An electrochromic layer is integrated into the clear portion of the face shield. The electrochromic layer is turned on when the face shield is in the second position to inhibit light from passing through the clear portion thereby facilitating the clear portion to shade the user when the pivoting band is in the second position. The electrochromic layer is turned off when the pivoting band is in the first position to facilitate the user to see through the clear portion.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention

The disclosure relates to face shield devices and more particularly pertains to a new face shield device for shading a user's eyes when a face shield is pivoted upwardly. The device includes a head harness and a pivoting band that is pivotally attached to the head harness and a face shield attached to the pivoting band. The device includes an electrochromic layer integrated into the face shield which is turned on when the pivoting band is pivoted to raise the face shield such that the face shield is darkened. The electrochromic layer is turned off when the pivoting band is pivoted to lower the face shield such the face shield is transparent.

### (2) DESCRIPTION OF RELATED ART INCLUDING INFORMATION DISCLOSED UNDER 37 CFR 1.97 AND 1.98

The prior art relates to face shield devices including a variety of helmets and face visors that each includes an electrochromic layer and an ambient light sensor for actuating the electrochromic layer when ambient light is above a pre-determined intensity. In no instance does the prior art disclose a face shield that includes an electrochromic layer and a pair of rotation sensors that actuate the electrochromic layer when the face shield is pivoted upwardly and de-actuates the electrochromic layer when the face shield is pivoted downwardly.

### (H) BRIEF SUMMARY OF THE INVENTION

An embodiment of the disclosure meets the needs presented above by generally comprising a head harness that can be worn on a user's head and a pivoting band that is pivotally attached to the head harness. The pivoting band is positionable in a first position or a second position. A face shield is attached to the pivoting band and the face shield has a clear portion and an opaque portion. An electrochromic layer is integrated into the clear portion of the face shield. The electrochromic layer is turned on when the face shield is in the second position to inhibit light from passing through the clear portion thereby facilitating the clear portion to shade the user when the pivoting band is in the second position. The electrochromic layer is turned off when the pivoting band is in the first position to facilitate the user to see through the clear portion.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of an electrochromic face shield device according to an embodiment of the disclosure showing an electrochromic layer being turned off.

FIG. 2 is a top perspective view of an embodiment of the disclosure showing an electrochromic layer being turned on.

FIG. 3 is a front view of an embodiment of the disclosure.

FIG. 4 is a cross sectional view taken along line 4-4 of FIG. 3 of an embodiment of the disclosure.

FIG. 5 is a left side view of an embodiment of the disclosure showing a pivoting member in a second position and an electrochromic layer being turned on.

FIG. 6 is a cross sectional view taken along line 6-6 of FIG. 5 of an embodiment of the disclosure.

FIG. 7 is a perspective in-use view of an embodiment of the disclosure showing a face shield in a first position.

FIG. 8 is a perspective in-use view of an embodiment of the disclosure showing a face shield in a second position.

### (J) DETAILED DESCRIPTION OF THE INVENTION

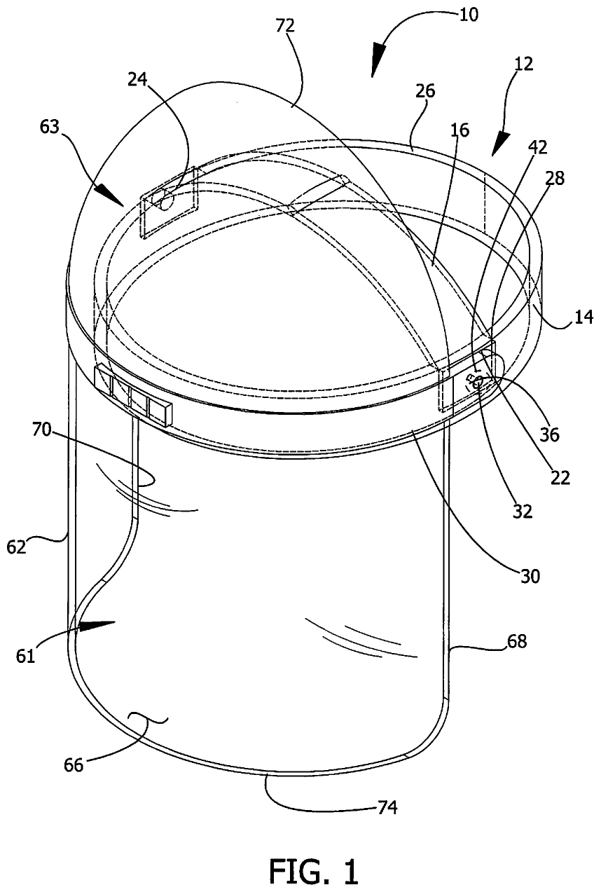

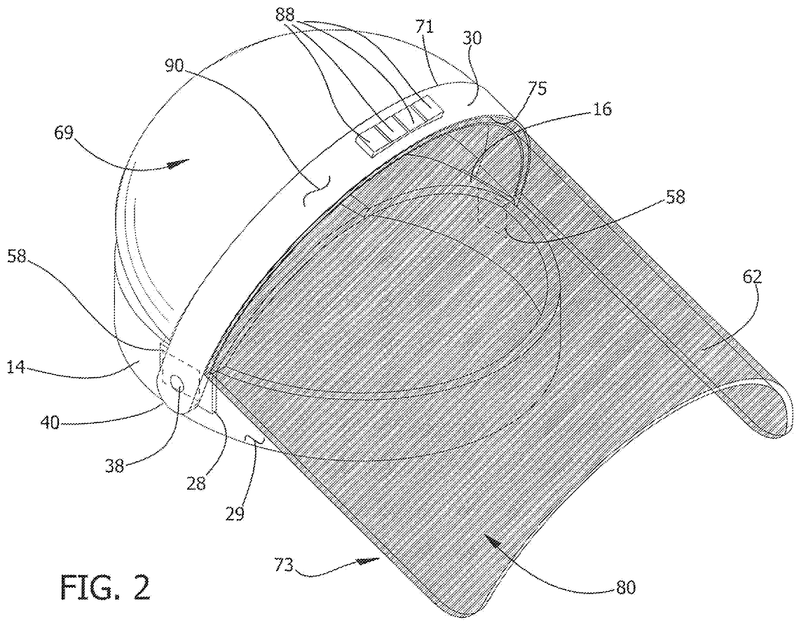

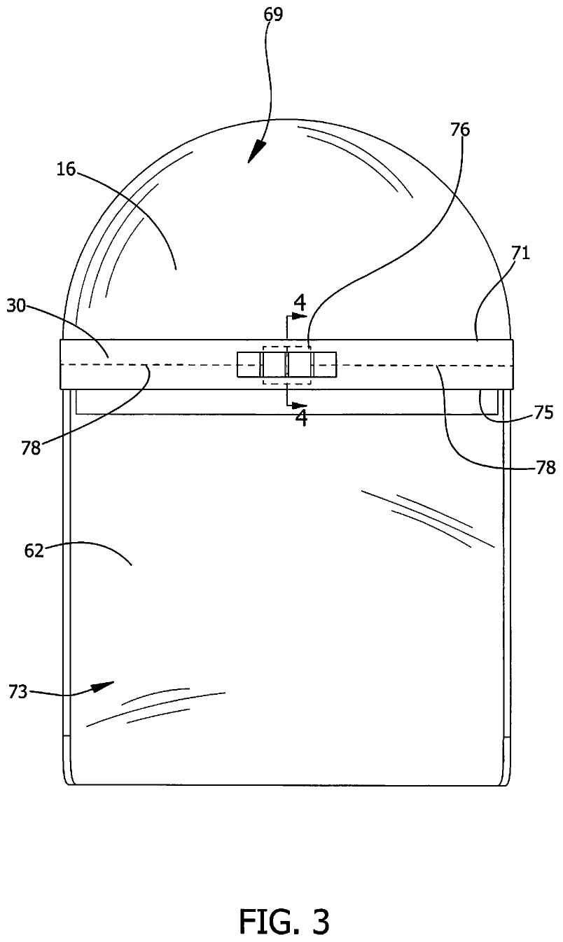

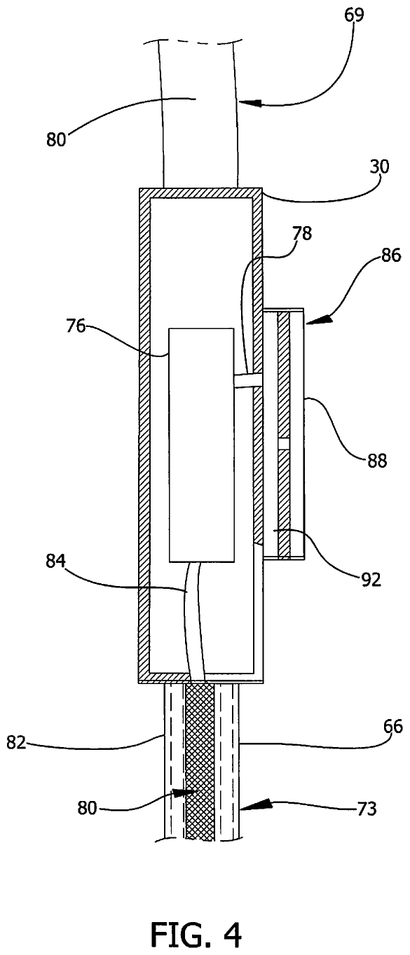

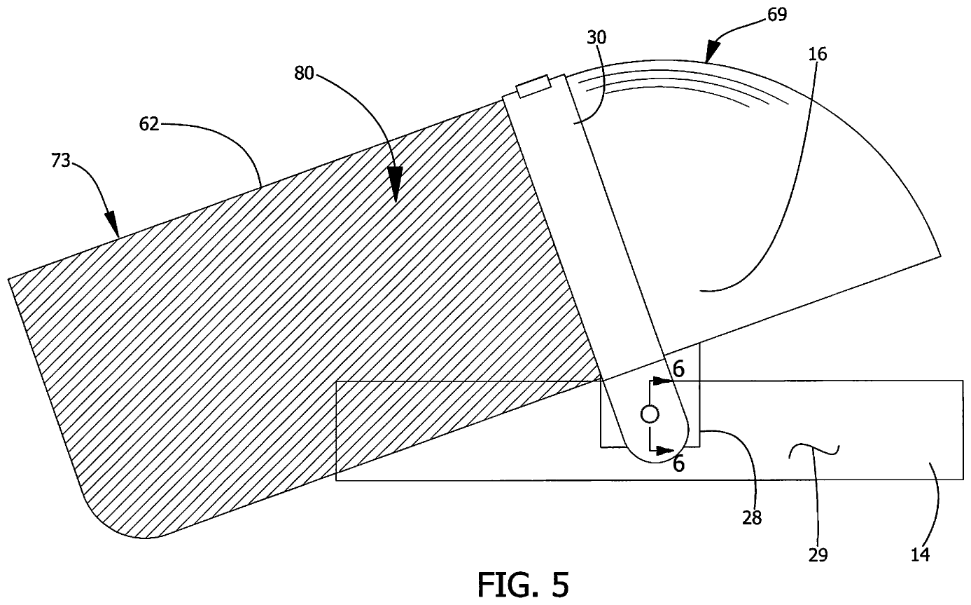

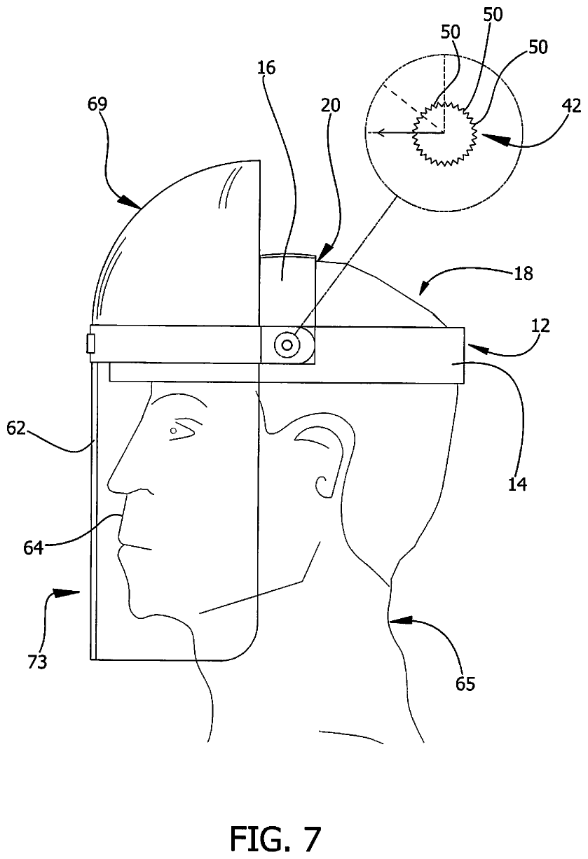

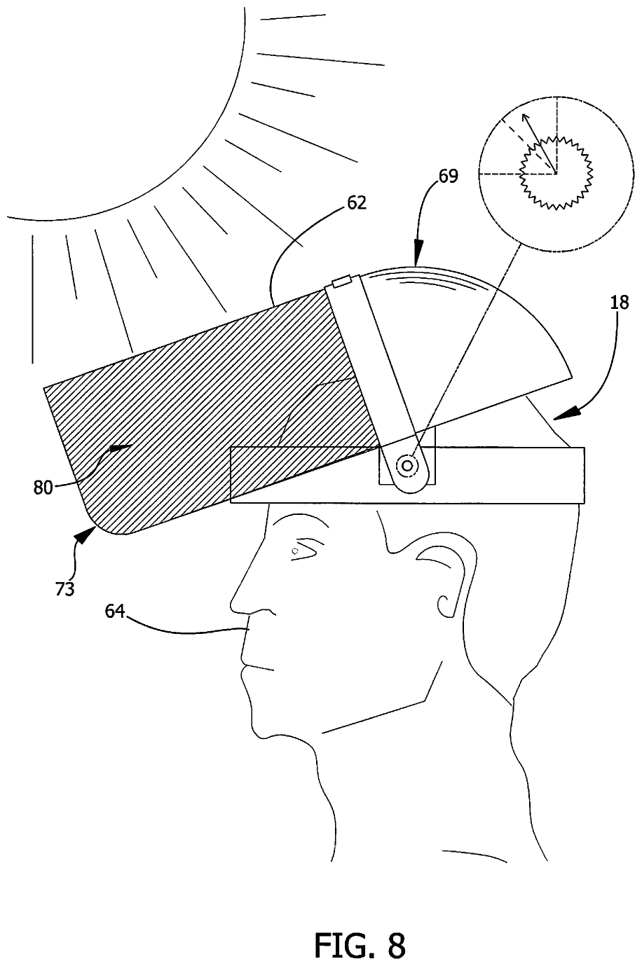

With reference now to the drawings, and in particular to FIGS. 1 through 8 thereof, a new face shield device embodying the principles and concepts of an embodiment of the disclosure and generally designated by the reference numeral 10 will be described.

As best illustrated in FIGS. 1 through 8, the electrochromic face shield device 10 generally comprises a head harness 12 that has a horizontal band 14 which forms a closed loop and a vertical band 16 curving upwardly from the horizontal band 14. The head harness 12 can be worn on a user's head 18 having the horizontal band 14 encircling the user's head 18 and having the vertical band 16 curving across a top 20 of the user's head 18. Each of a first end 22 and a second end 24 of the vertical band 16 is coupled to a top edge 26 of the horizontal band 14 and the horizontal band 14 has a pair of pivot points 28 each is disposed on an outer surface 29 of the horizontal band 14. Additionally, each of the pair of pivot points 28 is aligned with a respective one of the first end 22 and the second end 24 of the vertical band 16.

A pivoting band 30 is provided and the pivoting band 30 is pivotally attached to the head harness 12. The pivoting band 30 is positionable in a first position having the pivoting band 30 extending along the horizontal band 14 of the head harness 12. Additionally, the pivoting band 30 is positionable in a second position having the pivoting band 30 extending along the vertical band 16 of the head harness 12. The pivoting band 30 has a first pivot 32 that is disposed adjacent to a primary end 36 of the pivoting band 30 and the pivoting band 30 has a second pivot 38 that is disposed adjacent to a secondary end 40 of the pivoting band 30. Each of the first pivot 32 and the second pivot 38 is pivotally coupled to a respective one of the pair of pivot points 28 on the horizontal band 14 of the head harness 12.

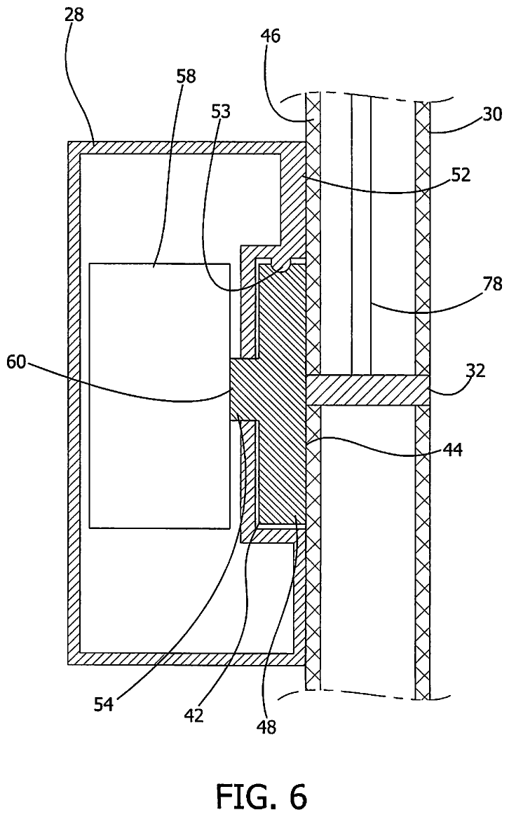

A pair of gears 42 is provided and each of the pair of gears 42 has a primary surface 44 that is attached to a first surface 46 of the pivoting band 30 at a point located adjacent to a respective one of the primary end 36 and the secondary end 40 of the pivoting band 30. Each of the gears 42 has an outer edge 48 comprising a series of repeating teeth 50. Additionally, each of the pair of gears 42 is recessed into an outwardly facing wall 52 of a respective one of the pivot points 28 on the horizontal band 14 of the head harness 12 such that the series of repeating teeth 50 on the outer edge 48 of each of the pair of gears 42 releasably engages a knob 53 in the respective pivot point 28. In this way the pivoting band 30 is retained at a variety of angles between the first position and the second position. Additionally, each of the pair of gears 42 has an output shaft 54 extends away from a secondary surface 56 of the gears 42 which extends through the outwardly facing wall 52 of the respective pivot point 28. As is most clearly shown in FIG. 6, each of the gears 42 is coupled to a respective one of the first pivot 32 and the second pivot 34 and each of the pair of gears 42 and each of the first pivot 32 and the second pivot 34 may be comprised of an electrically conductive material.

A pair of rotation sensors 58 is provided and each of the pair of rotation sensors 58 is integrated into the head harness 12. Each of the pair of rotation sensors 58 is in communication with the pivoting band 30 thereby facilitating each of the pair of rotation sensors 58 to sense when the pivoting band 30 is in the first position or the second position. Each of the pair of rotation sensors 58 is positioned within a respective one of the pair of pivot points 28 on the horizontal band 14 of the head harness 12 and each of the rotation sensors 58 is coupled to a distal end 60 of the output shaft 54 on a respective one of the pair of gears 42. Furthermore, each of the pair of rotation sensors 58 may comprise an electronic rotation sensor or the like that is set to trigger at a pre-determined angle of rotation which corresponds to pivoting the pivoting band 30 between the first position and the second position.

A face shield 62 is attached to the pivoting band 30 such that the face shield 62 can shield the user's face 64 from debris when the pivoting band 30 is in the first position. Conversely, the face shield 62 can be spaced above the user's face 64 when the pivoting band 30 is in the second position. The face shield 62 has a clear portion 61 that is comprised of a translucent material to pass light through the clear portion 61 of the face shield 62 thereby facilitating the user 65 to see through the face shield 62 when the face shield 62 is in the first position. The face shield has an opaque portion 63 that is comprised of an opaque material thereby inhibiting light from passing through the opaque portion 63. Additionally, the face shield 62 is comprised of a rigid material, including but not being limited to polycarbonate, which conforms to the America National Standards Institute rating of Z87.1

The face shield 62 has an outwardly facing surface 66 extending between a first lateral edge 68 and a second lateral edge 70 and the outwardly facing surface 66 is concavely arcuate between the first lateral edge 68 and the second lateral edge 70. The face shield 62 has a top edge 72 and a bottom edge 74 and the top edge 72 curves upwardly between the first lateral edge 68 and the second lateral edge 70 such that the outwardly facing surface 66 curves rearwardly to meet the top edge 72. Additionally. the bottom edge 74 curves forwardly between the first lateral edge 68 and the second lateral edge 70. The pivoting band 30 is positioned closer to the top edge 72 than the bottom edge 74 thereby defining an upper portion 69 of the face shield 62 extending between an upper edge 71 of the pivoting band 30 and the top edge 72 of the face shield 62. Additionally, the pivoting band 30 defines a lower portion 73 of the face shield 62 extending between a lower edge 75 of the pivoting band 30 and the bottom edge 74 of the face shield 62. The lower portion 73 of the face shield 62 defines the clear portion 61 of the face shield 62 and the upper portion 69 of the face shield 62 defines the opaque portion 63 of the face shield 62.

A processor 76 is integrated into the pivoting band 30 and the processor 76 is electrically coupled to each of the pair of rotation sensors 58. The processor 76 receives a de-actuate input when the pair of rotation sensors 58 sense that the face shield 62 is in the first position. Additionally, the processor 76 receives an actuate input when the pair of rotation sensors 58 senses that the face shield 62 is in the second position. A pair of rotation conductors 78 is provided and each of the pair of rotation conductors 78 is integrated into the pivoting band 30. Each of the pair of rotation conductors 78 is electrically coupled between a respective one of the pair of rotation sensors 58 and the processor 76. As is shown in FIG. 6, each of the rotation conductors 78 may be electrically coupled to a respective one of the first pivot 32 and the second pivot 34 in the pivoting band 30.

An electrochromic layer 80 is integrated into clear portion 61 of the face shield 62 and the electrochromic layer 80 is in communication with the pair of rotation sensors 58. The electrochromic layer 80 is turned on when the pair of rotation sensors 58 senses that the face shield 62 is in the second position such that the electrochromic layer 80 darkens. In this way the electrochromic layer 80 inhibits light from passing through the clear portion 61 of the face shield 62 thereby facilitating the clear portion 61 of the face shield 62 to shade the user 65 when the face shield 62 is in the second position. The electrochromic layer 80 is turned off when the pair of rotation sensors 58 senses that the face shield 62 is in the first position to facilitate the user 65 to see through the clear portion 61 of the face shield 62.

The electrochromic layer 80 may comprise an electrochromic film that employs liquid crystal exposed to a voltage for producing a tint and the electrochromic layer 80 is electrically coupled to the processor 76. The electrochromic layer 80 is turned on when the processor 76 receives the actuate input and the electrochromic layer 80 is turned off when the processor 76 receives the de-actuate input. Furthermore, the electrochromic layer 80 is positioned between the outwardly facing surface 66 of the face shield 62 and an inwardly facing surface 82 corresponding to the lower portion 73 of the face shield 62. Furthermore, the electrochromic layer 80 extends between the lower edge 75 of the pivoting band 30 and the bottom edge 74 of the face shield 62.

A face shield conductor 84 is integrated into the pivoting band 30 and the face shield conductor 84 is electrically coupled between the processor 76 and the electrochromic layer 80. A power supply 86 is integrated into the pivoting band 30 and the power supply 86 is electrically coupled to the processor 76. The power supply 86 comprises a plurality of solar panels 88 that is each coupled to an outwardly facing surface 90 of the pivoting band 30 such that each of the plurality of solar panels 88 is exposed to sunlight. The power supply 86 includes a rechargeable battery 92 that is integrated into the pivoting band 30. The rechargeable battery 92 is electrically coupled to the processor 76 and the rechargeable battery 92 is electrically coupled to the plurality of solar panels 88 for charging the rechargeable battery 92.

In use, the head harness 12 is worn on the user's head 18 and the face shield 62 is placed in the first position to facilitate the face shield 62 to protect the user's face 64 from debris that results from employing power tools, for example. Furthermore, the electrochromic layer 80 is turned off when the face shield 62 is in the first position to facilitate the user 65 to see through the clear portion 61 of the face shield 62. The face shield 62 is pivoted into the second position when the user 65 does not wish the face shield 62 to be positioned in front of their face 64. Furthermore, the electrochromic layer 80 is turned on when the face shield 62 is in the second position thereby inhibiting light from passing through the clear portion 61 of the face shield 62. In this way the clear portion 61 of the face shield 62 can shade the user's face 64 when the user 65 is working outdoors, for example. Additionally, the solar panels 88 continuously charge the rechargeable battery 92 while the head harness 12 is exposed to sunlight.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An electrochromic face shield device which darkens when the face shield is lifted for shading the sun for a user, said device comprising;
a head harness having a horizontal band forming a closed loop and a vertical band curving upwardly from said horizontal band wherein said head harness is configured to be worn on a user's head having said horizontal band encircling the users head and having said vertical band curving across a top of the user's head;
a pivoting band being pivotally attached to said head harness, said pivoting band being positionable in a first position having said pivoting band extending along said horizontal band of said head harness, said pivoting band being positionable in a second position having said pivoting band extending along said vertical band of said head harness;
a pair of rotation sensors, each of said pair of rotation sensors being integrated into said head harness, each of said pair of rotation sensors being in communication with said pivoting band thereby facilitating each of said pair of rotation sensors to sense when said pivoting band is in said first position or said second position, each of said pair of rotation sensors being positioned within a respective one of a pair of pivot points on said horizontal harness of said head band;
a face shield being attached to said pivoting band wherein said face shield is configured to shield the user's face from debris when said pivoting band is in said first position and wherein said face shield is configured to be spaced above the user's face when said pivoting band is in said second position, said face shield having a clear portion being comprised of a translucent material wherein said clear portion of said face shield is configured to pass light through said face shield thereby facilitating the user to see through said clear portion of said face shield when said face shield is in said first position, said face shield having an opaque portion being comprised of an opaque material wherein said opaque portion is configured to inhibit light from passing through said opaque portion; and
an electrochromic layer being integrated into clear portion of said face shield, said electrochromic layer being in communication with said pair of rotation sensors, said electrochromic layer being turned on when said pair of rotation sensors senses that said pivoting band is in said second position such that said electrochromic layer darkens wherein said electrochromic layer is configured to inhibit light from passing through said clear portion of said face shield thereby facilitating said clear portion of said face shield to shade the user when said face shield is in said second position, said electrochromic layer being turned off when said pair of rotation sensors senses that said pivoting band is in said first position wherein said electrochromic layer is configured to facilitate the user to see through said clear portion of said face shield.

2. The electrochromic face shield device according to claim 1, wherein:
each of a first end and a second end of said vertical band is coupled to a top edge of said horizontal band;
said horizontal band has said pair of pivot points each being disposed on an outer surface of said horizontal band, each of said pair of pivot points being aligned with a respective one of said first end and said second end of said vertical band; and
said pivoting band has a first pivot being disposed adjacent to a primary end of said pivoting band, said pivoting band having a second pivot being disposed adjacent to a secondary end of said pivoting band, each of said first pivot and said second pivot being pivotally coupled to a respective one of said pair of pivot points on said horizontal band of said head harness.

3. The electrochromic face shield device according to claim 2, further comprising:
a pair of gears;
wherein each of said pair of gears has a primary surface being attached to a first surface of said pivoting band at a point located adjacent to a respective one of said primary end and said secondary end of said pivoting band;
wherein each of said gears has an outer edge comprising a series of repeating teeth:
wherein each of said pair of gears is recessed into an outwardly facing wall of a respective one of said pivot points on said horizontal band of said head harness such that said series of repeating teeth on said outer edge of each of said pair of gears releasably engages a knob in said respective pivot point for releasably retaining said pivoting band at a variety of angles between said first position and said second position; and
wherein each of said pair of gears has an output shaft extending away from a secondary surface of said gears which extends through said outwardly facing wall of said respective pivot point.

4. The electrochromic face shield device according to claim 3, wherein each of said rotation sensors is coupled to a distal end of said output shaft on a respective one of said pair of gears.

5. The electrochromic face shield device according to claim 1, wherein:
said face shield has an outwardly facing surface extending between a first lateral edge and a second lateral edge;
said outwardly facing surface is concavely arcuate between said first lateral edge and said second lateral edge;
said face shield has a top edge and a bottom edge;
said top edge curves upwardly between said first lateral edge and said second lateral edge such that said outwardly facing surface curves rearwardly to meet said top edge;
said bottom edge curves forwardly between said first lateral edge and said second lateral edge; and
said pivoting band is positioned closer to said top edge than said bottom edge thereby defining an upper portion of said face shield extending between an upper edge of said pivoting band and said top edge of said face shield, said pivoting band defining a lower portion of said face shield extending between a lower edge of said pivoting band and said bottom edge of said face shield;
said lower portion of said face shield defines said clear portion of said face shield; and
said upper portion of said face shield defines said opaque portion of said face shield.

6. The electrochromic face shield device according to claim 1, further comprising:
a processor being integrated into said pivoting band;
wherein said processor is electrically coupled to each of said pair of rotation sensors;
wherein said processor receives a de-actuate input when said pair of rotation sensors sense that said face shield is in said first position; and
wherein said processor receives an actuate input when said pair of rotation sensors senses that said face shield is in said second position.

7. The electrochromic face shield device according to claim 6, further comprising a pair of rotation conductors, each of said pair of rotation conductors being integrated into said pivoting band, each of said pair of rotation conductors being electrically coupled between a respective one of said pair of rotation sensors and said processor.

8. The electrochromic face shield device according to claim 6, wherein:
said electrochromic layer is electrically coupled to said processor;
said electrochromic layer is turned on when said processor receives said actuate input;
said electrochromic layer is turned off when said processor receives said de-actuate input;
said electrochromic layer is positioned between said outwardly facing surface of said face shield and an inwardly facing surface of said face shield corresponding to said clear portion of said face shield; and
said electrochromic layer extends between a lower edge of said pivoting band and said bottom edge of said face shield.

9. The electrochromic face shield device according to claim 6, further comprising a face shield conductor being integrated into said pivoting band, said face shield conductor being electrically coupled between said processor and said electrochromic layer.

10. The electrochromic face shield device according to claim 6, further comprising a power supply being integrated into said pivoting band, said power supply being electrically coupled to said processor, said power supply comprising:
a plurality of solar panels, each of said plurality of solar panels being coupled to an outwardly facing surface of said pivoting band wherein each of said plurality of solar panels is configured to be exposed to sunlight; and
a rechargeable battery being integrated into said pivoting band, said rechargeable battery being electrically coupled to said processor, said rechargeable battery being electrically coupled to said plurality of solar panels for charging said rechargeable battery.

11. An electrochromic face shield device which darkens when the face shield is lifted for shading the sun for a user, said device comprising:
a head harness having a horizontal band forming a closed loop and a vertical band curving upwardly from said horizontal band wherein said head harness is configured to be worn on a user's head having said horizontal band encircling the users head and having said vertical band curving across a top of the user's head, each of a first end and a second end of said vertical band being coupled to a top edge of said horizontal band, said horizontal band having a pair of pivot points each being disposed on an outer surface of said horizontal band, each of said pair of pivot points being aligned with a respective one of said first end and said second end of said vertical band;
a pivoting band being pivotally attached to said head harness, said pivoting band being positionable in a first position having said pivoting band extending along said horizontal band of said head harness, said pivoting band being positionable in a second position having said pivoting band extending along said vertical band of said head harness, said pivoting band having a first pivot being disposed adjacent to a primary end of said pivoting band, said pivoting band having a second pivot being disposed adjacent to a secondary end of said pivoting band, each of said first pivot and said second pivot being pivotally coupled to a respective one of said pair of pivot points on said horizontal band of said head harness;
pair of gears, each of said pair of gears having a primary surface being attached to a first surface of said pivoting band at a point located adjacent to a respective one of said primary end and said secondary end of said pivoting band, each of said gears having an outer edge comprising a series of repeating teeth, each of said pair of gears being recessed into an outwardly facing wall of a respective one of said pivot points on said horizontal band of said head harness such that said series of repeating teeth on said outer edge of each of said pair of gears releasably engages a knob in said respective pivot point for releasably retaining said pivoting band at a variety of angles between said first position and said second position, each of said pair of gears having an output shaft extending away from a secondary surface of said gears which extends through said outwardly facing wall of said respective pivot point;
a pair of rotation sensors, each of said pair of rotation sensors being integrated into said head harness, each of said pair of rotation sensors being in communication with said pivoting band thereby facilitating each of said pair of rotation sensors to sense when said pivoting band is in said first position or said second position, each of said pair of rotation sensors being positioned within a respective one of said pair of pivot points on said horizontal harness of said head band, each of said rotation sensors being coupled to a distal end of said output shaft on a respective one of said pair of gears;
a face shield being attached to said pivoting band wherein said face shield is configured to shield the user's face from debris when said pivoting band is in said first position and wherein said face shield is configured to be spaced above the user's face when said pivoting band is in said second position, said face shield having a clear portion being comprised of a translucent material wherein said clear portion of said face shield is configured to pass light through said clear portion of said face shield thereby facilitating the user to see through said clear portion of said face shield when said pivoting band is in said first position, said face shield having an opaque portion being comprised of an opaque material wherein said opaque portion is configured to inhibit light from passing through said opaque portion, said face shield having an outwardly facing surface extending between a first lateral edge and a second lateral edge, said outwardly facing surface being concavely arcuate between said first lateral edge and said second lateral edge, said face shield having a top edge and a bottom edge, said top edge curving upwardly between said first lateral edge and said second lateral edge such that said outwardly facing surface curves rearwardly to meet said top edge, said bottom edge curving forwardly between said first lateral edge and said second lateral edge, said pivoting band being positioned closer to said top edge than said bottom edge thereby defining an upper portion of said face shield extending between an upper edge of said pivoting band and said top edge of said face shield, said pivoting band defining a lower portion of said face shield extending between a lower edge of said pivoting band and said bottom edge of said face shield, said lower portion of said face shield defining said clear portion of said face shield, said upper portion of said face shield defining said opaque portion of said face shield;
a processor being integrated into said pivoting band, said processor being electrically coupled to each of said pair of rotation sensors, said processor receiving a de-actuate input when said pair of rotation sensors sense that said face shield is in said first position, said processor receiving an actuate input when said pair of rotation sensors senses that said face shield is in said second position;
a pair of rotation conductors, each of said pair of rotation conductors being integrated into said pivoting band, each of said pair of rotation conductors being electrically coupled between a respective one of said pair of rotation sensors and said processor;
an electrochromic layer being integrated into clear portion of said face shield, said electrochromic layer being in communication with said pair of rotation sensors, said electrochromic layer being turned on when said pair of rotation sensors senses that said face shield is in said second position such that said electrochromic layer darkens wherein said electrochromic layer is configured to inhibit light from passing through said clear portion of said face shield thereby facilitating said face shield to shade the user when said face shield is in said second position, said electrochromic layer being turned off when said pair of rotation sensors senses that said face shield is in said first position wherein said electrochromic layer is configured to facilitate the user to see through said clear portion of said face shield, said electrochromic layer being electrically coupled to said processor, said electrochromic layer being turned on when said processor receives said actuate input, said electrochromic layer being turned off when said processor receives said de-actuate input, said electrochromic layer being positioned between said outwardly facing surface of said face shield and an inwardly facing surface of said face shield corresponding to said lower portion of said face shield, said electrochromic layer extending between said lower edge of said pivoting band and said bottom edge of said face shield;
a face shield conductor being integrated into said pivoting band, said face shield conductor being electrically coupled between said processor and said electrochromic layer;
a power supply being integrated into said pivoting band, said power supply being electrically coupled to said processor, said power supply comprising:
a plurality of solar panels, each of said plurality of solar panels being coupled to an outwardly facing surface of said pivoting band wherein each of said plurality of solar panels is configured to be exposed to sunlight; and
a rechargeable battery being integrated into said pivoting band, said rechargeable battery being electrically coupled to said processor, said rechargeable battery being electrically coupled to said plurality of solar panels for charging said rechargeable battery.
